(19) United States
(12) Patent Application Publication
(10) Pub. No.: US 2013/0070183 A1
(43) Pub. Date: Mar. 21, 2013

(54) OPTICAL FILM, POLARIZING PLATE, AND IMAGE DISPLAY DEVICE

(71) Applicants: Kazuaki WATANABE, Tokyo (JP); Takatoshi Yosomiya, Tokyo (JP)

(72) Inventors: Kazuaki WATANABE, Tokyo (JP); Takatoshi Yosomiya, Tokyo (JP)

(21) Appl. No.: 13/234,349

(22) Filed: Sep. 16, 2011

(51) Int. Cl. G02F 1/1335; G02B 5/22

(52) U.S. Cl. 349/70; 252/589; 349/96

(57) ABSTRACT

Disclosed is an optical film excellent in optical characteristics and UV absorbability and excellent in outward appearance in which the UV absorbent does not bleed out. The optical film is formed of a polypropylene resin mixture containing (A) a polypropylene resin containing a propylene polymer, (B) a 2-(hydroxyphenyl)benzotriazole derivative 1, and (C) a 2-(hydroxyphenyl)benzotriazole derivative 2, wherein the 2-(hydroxyphenyl)benzotriazole derivative 2 (C) is 2-(2-hydroxy-3-tert-butyl-5-methylphenyl)-5-chlorobenzotriazole, and the content ratio of (C) to the total amount of (B) and (C) is from 8 to 60% by mass.

### TECHNICAL FIELD

The present invention relates to an optical member for use in image display devices, more precisely to an optical film having UV absorbability and excellent in optical characteristics. The present invention also relates to a polarizing plate provided with the above-mentioned optical film as formed on at least one side of the polarizer therein, and to an image display device comprising the polarizing plate.

### BACKGROUND ART

An optical film is a film for industrial materials that are required to be transparent, and for example, there may be mentioned films for windows such as shatterproof films, UV-protective films, etc., films for displays such as polarizer-protective films, optical compensatory films, antireflection films, etc., as well as films for industrial materials such as surface-protective films to be used for steel plates, architectural design materials and the like for protection from scratching/contamination, etc. Of such optical films, those for use in image display devices have become specifically noted with the advances in image display devices such as liquid crystal display devices comprising a liquid crystal cell, organic electroluminescence display devices, touch panels, etc. Optical films include retardation films to be arranged for optical compensation, optical films to be used for polarizer protection, etc. As the retardation film, there are known retardation films to be produced by stretching propylene (see Patent Literature 1 and Patent Literature 2).

A polarizing plate is an optical member that has a function of transmitting only a light having a specific vibration direction and preventing the other light from passing therethrough, and is widely used in the above-mentioned image display devices. As the polarizing plate, generally used are those that are so designed as to have an optical film for polarizer protection provided on one side or both sides of a polarizer. In this, the polarizer has a function of transmitting only a light having a specific vibration direction; for this, widely used is monoaxially-stretched polyvinyl alcohol (hereinafter referred to as “PVA”) film dyed with iodine, a dichroic dye or the like, and recently a film formed by coating has become used, but is generally thin and is problematic in that its strength is poor.

Regarding the polarizer to be used in the polarizing plate, the polarizer is a member to be formed of an organic material and has a problem in that it is readily deteriorated by UV rays. It is generally known that the deterioration of the organic material (resin) to constitute a polarizer is caused by exposure to UV rays having a wavelength of from 280 to 400 nm, and it may be possible to prevent polarizer deterioration or liquid crystal deterioration by absorbing (blocking) the UV rays falling within the range before arrival thereof at polarizer.

UV rays having a shorter wavelength may damage more strongly optical films; however, oxygen and the like in the ozone layer or in air could absorb the sunlight having a short wavelength, and therefore, the amount of UV rays having a wavelength of 280 nm or less and capable of reaching the ground is small. On the other hand, as so mentioned in the above, the deterioration of polypropylene resin is nearly almost by exposure to UV rays falling within a wavelength range of from 280 to 400 nm. Accordingly, for preventing the deterioration of polypropylene resin, it is necessary to absorb the light rays falling within the range by using a UV absorbent capable of absorbing the light rays in the range. Therefore, the polarizer-protective film to be arranged on the surface of the polarizer is required to have UV absorbability and have a function of protecting the polarizer, the liquid crystal cell inside the polarizing plate, the retardation film and the adhesive layers inside the display from UV rays. In addition, there is a possibility that the polarizer-protective film may also be deteriorated through exposure to high temperature or to UV rays, and therefore, it is necessary to impart UV absorbability to the polarizer-protective film itself, from the viewpoint of preventing the polarizer-protective film itself from being deteriorated.

In particular, in a liquid crystal display device using a fluorescent tube as the backlight thereof, it is indispensable to impart UV absorbability to the protective film to be used in the display device. In general, a liquid crystal display device using a fluorescent tube as the backlight thereof comprises two polarizers arranged to sandwich the liquid crystal cell therebetween, in which a protective film is arranged on both sides of the polarizer. In this, light is directly radiated from the backlight fluorescent tube to the polarizing plate, and therefore the protective film for the polarizing plate closer to the backlight must be indispensably given UV absorbability. Accordingly, in general, a polarizer-protective film given UV absorbability is stuck to the backlight side of the polarizer of the backlight-side polarizing plate. As the polarizer-protective film for the polarizing plate on the backlight side, there are known a UV absorbent-added polyethylene terephthalate film (see Patent Literature 3), a (meth)acrylic resin film (see Patent Literature 4), a resin film containing a cyclic olefinic polymer and a vinylic polymer (see Patent Literature 5), etc. However, these resin films are expensive, and more inexpensive materials are desired.

Given the situation, there has been proposed a polarizer-protective optical film formed by the use of a polypropylene resin, as a low-cost polarizer-protective optical film (see Patent Literature 6 and Patent Literature 7). However, in general, polypropylene resin itself tends to be deteriorated at high temperature or by direct sunlight; and therefore, in case where a polypropylene resin is used for a polarizer-protective optical film, the polypropylene resin must be given UV absorbability.

As the UV absorbent generally used for giving UV absorbability, there may be mentioned a wide variety of compounds such as oxybenzophenone compounds, benzotriazole compounds, salicylate compounds, benzophenone compounds, cyanoacrylate compounds, nickel complex compounds, etc. In addition, there is known a case of adding the above-mentioned UV absorbent to propylene resin (see Patent Literature 8). However, in case where a polarizer-protective film is produced by mixing a UV absorbent in a polypropylene resin, many UV absorbents worsen the optical characteristics such as high transparency, low haze, in-plane retardation or the like of polypropylene resin. The degradation of the optical characteristics owing to the use of UV absorbent brings about a serious problem even though the degree thereof is on the level that could be accepted in other applications, since the use of polarizer-protective optical film requires high-level optical characteristics. In addition, some UV absorbents could not exhibit the UV absorbability thereof when a large amount thereof is not added; or many other UV absorbents may cause a phenomenon (bleeding out) of such that even when a small amount thereof is added, the UV absorbent bleeds out on the surface of a film during film formation, thereby detracting from the processing aptitude and the product quality of the formed film. Further, in case where two or more different types of UV absorbents are combined and used, there may occur a problem in that the frequency of bleeding out increases depending on the amount and the blend ratio of the UV absorbents and on the type of the UV absorbents to be combined. Consequently, not only the type and the combination of the UV absorbents to be combined but also the amount and the blend ratio thereof must be selected from the viewpoint of the bleeding-out tendency thereof, or that is, as to whether or not the UV absorbent may bleed out when added to resin.

In the previous invention, the present inventors have found that a polypropylene resin that comprises a benzotriazole phenol as the UV absorbent therein is suitable for a polarizer-protective film since the bleeding out of the absorbent is low (see Patent Literature 9). However, a polypropylene resin produced by the use of a metallocene catalyst is good in point of optical characteristics of small haze, excellent transparency, high visible light transmittance and low birefringence.

Regarding the UV absorbability of optical films, it is generally said that the light transmittance thereof at a wavelength of 380 nm is preferably at most 10% (“KONICA TECHNICAL REPORT”, Vol. 16, (2003), p. 76); and it is desired to develop an optical film having a sufficient UV absorbability even in a wavelength region of from 370 to 400 nm. However, the optical film formed of the UV absorbent-added polypropylene resin, as disclosed in the above-mentioned Patent Literature 9, could satisfy a good UV absorbability in a wavelength region of at most 370 nm in a UV region, but in some cases, the UV absorbability thereof in a wavelength region of from 370 to 400 nm in a UV region is often insufficient in severer environments or under severer standards. More concretely, the UV absorbent, 2-(2H-benzotriazol-2-yl)-4-(1,1,3,3-tetramethylbutyl)-phenol or 2-(2H-benzotriazol-2-yl)-4,6-di-tert-pentylphenol used in Patent Literature 4 and Patent Literature 5 could not attain a sufficient UV absorbability in a wavelength region of from 370 to 400 nm. Further in this case, when the amount to be added of the UV absorbent is increased for the purpose of enhancing the UV absorbability in the wavelength region of from 370 to 400 nm, the absorbent may often bleed out to thereby detract from the transparency and the processing aptitude of the film.

### Citation List

### Patent Literatures

Patent Literature 1: WO2007/108562
Patent Literature 2: JP-A 2007-286615
Patent Literature 3: JP-A 2009-169393
Patent Literature 4: JP-A 2007-17555
Patent Literature 5: JP-A 2006-188555
Patent Literature 6: JP-A 2008-146023
Patent Literature 7: JP-A 2007-334295
Patent Literature 8: JP-A 2007-45070
Patent Literature 9: WO2009/51188

### TECHNICAL PROBLEM

The present invention has been made under the situation as above, and an object of the present invention is to provide an optical film excellent in optical characteristics and UV absorbability and excellent in outward appearance in which the UV absorbent does not bleed out. Another object is to provide a high-performance polarizing plate and image display device using the optical film.

### SOLUTION TO PROBLEM

The present inventors have assiduously studied for the purpose of attaining the above-mentioned objects and, as a result, have found that, when two types of UV absorbents are combined in a specific blend ratio and used in a polypropylene resin containing a propylene polymer, then the above-mentioned problems can be solved. The inventors have completed the present invention on the basis of this finding.

Specifically, the summary of the present invention is as follows:

1. An optical film formed of a polypropylene resin mixture containing (A) a polypropylene resin containing a propylene polymer, (B) a 2-(hydroxyphenyl)benzotriazole derivative 1, and (C) a 2-(hydroxyphenyl)benzotriazole derivative 2, wherein the 2-(hydroxyphenyl)benzotriazole derivative 2 (C) is 2-(2-hydroxy-3-tert-butyl-5-methylphenyl)-5-chlorobenzotriazole, and the content ratio of (C) to the total amount of (B) and (C) is from 8 to 60% by mass.

2. The optical film of the above 1, wherein the 2-(hydroxyphenyl)benzotriazole derivative 1 (B) is at least one selected from 2-[2-hydroxy-5-(1,1,3,3-tetramethylbutyl)phenyl]benzotriazole and 2-(2-hydroxy-3,5-di-tert-pentylphenyl)benzotriazole.

3. The optical film of the above 1, wherein the propylene polymer is a random copolymer of propylene and α-olefin.

4. The optical film of the above 1, wherein the propylene polymer is a propylene copolymer produced by the use of a metallocene catalyst.

5. The optical film of the above 1, wherein the total content of (B) and (C) in the polypropylene resin mixture is from 0.3 to 1.5% by mass.

6. The optical film of the above 1, of which the light transmittance at a wavelength of 380 nm is at most 10%.

7. The optical film of the above 1, which is used in a polarizer-protective film.

8. A polarizing plate comprising, as arranged on at least one surface of the polarizer therein, the optical film of the above 7.

9. An image display device, wherein the polarizing plate of the above 8 is used.

10. A liquid crystal display device, wherein a polarizer is used, and wherein the optical film of the above 7 is arranged on one surface of the polarizer on the backlight side thereof and the backlight is a fluorescent tube.

### ADVANTAGEOUS EFFECTS OF INVENTION

According to the present invention, there can be obtained an optical film excellent in optical characteristics and UV absorbability and excellent in outward appearance in which the UV absorbent does not bleed out. Specifically, it has been found that, when the UV absorbents (B) and (C) are used in a specific ratio in the polypropylene resin (A), then these UV absorbents provide excellent UV absorbability, not detracting from the good optical characteristics of transparency, low haze, in-plane retardation and the like of the polypropylene resin.

The optical film of the present invention is especially favorable for polarizer protection, and use of the optical film provides a high-performance polarizing plate and image display device.

### BRIEF DESCRIPTION OF DRAWINGS

FIG. 1 is a view showing a configuration example of the polarizing plate of the present invention.

FIG. 2 is a view showing a configuration example of a liquid crystal display device using the polarizing plate of the present invention.

FIG. 3 is a graph showing the light transmittance of Example 1 and Comparative Example 1.

FIG. 4 is a graph showing the light transmittance of Examples 7 and 9 and Comparative Example 9.

### REFERENCE SIGNS LIST

1: Polarizer-Protective Optical Film
2: Polarizer
3: Polarizing Plate
4: Polarizer-Protective Film of Upper Polarizing Plate (panel upper-face side)
5: Polarizer of Upper Polarizing Plate
6: Polarizer-Protective Film of Upper Polarizing Plate (backlight side)
7: Upper Polarizing Plate
8: Liquid crystal Cell
9: Polarizer-Protective Film of Lower Polarizing Plate (panel upper-face side)
10: Polarizer of Lower Polarizing Plate
11: Polarizer-Protective Film of Lower Polarizing Plate (backlight side)
12: Lower Polarizing Plate
13: Backlight Zone
14: Antireflection Layer (or Antireflection Film)
15: Retardation film

### DESCRIPTION OF EMBODIMENTS

### [Optical Film]

The optical film of the present invention is formed by shaping a polypropylene resin mixture that contains a propylene polymer-containing polypropylene resin and a mixture of predetermined benzotriazole compounds (hereinafter this may be simply referred to as a “UV absorbent mixture”). More concretely, the optical film is formed of a polypropylene resin mixture containing (A) a polypropylene resin containing a propylene polymer (hereinafter this may be referred to as polypropylene resin (A)), (B) a 2-(hydroxyphenyl)benzotriazole derivative 1 (hereinafter this may be referred to as UV absorbent (B)), and (C) a 2-(hydroxyphenyl)benzotriazole derivative 2 (hereinafter this may be referred to as UV absorbent (C)), wherein the 2-(hydroxyphenyl)benzotriazole derivative 2 (C) is 2-(2-hydroxy-3-tert-butyl-5-methylphenyl)-5-chlorobenzotriazole, and the content ratio of (C) to the total amount of (B) and (C) is from 8 to 60% by mass.

The optical film of the present invention is described in detail hereinunder.

### <<(A) Propylene Polymer-Containing Polypropylene Resin

In the present invention, the polypropylene resin contains a propylene polymer, or that is, a propylene homopolymer or a copolymer of propylene and at least one comonomer (hereinafter this may be referred to as “propylene copolymer”). In the present invention, any of such propylene homopolymer and propylene copolymer may be used, and these may be used either singly or as a mixture of propylene homopolymer and at least one propylene copolymer or as a mixture of at least two propylene copolymers. Different types of polypropylene homopolymers and propylene copolymers that differ from each other in the proportion of the propylene-derived constitutive unit therein, or in the molecular weight, the tacticity or the like thereof may be mixed for use herein.

In the present invention, preferred is a propylene copolymer in consideration of the transparency and other optical properties of the film and in consideration of the fact that the UV absorbent mixture hardly bleeds out in the film; and as the propylene copolymer, preferred is a random copolymer of propylene and α-olefin.

As the α-olefin, preferred are ethylene and an α-olefin having from 4 to 18 carbon atoms, more preferred is an α-olefin having from 4 to 12 carbon atoms; and from the viewpoint of the copolymerizability thereof, preferred are 1-butene, 1-pentene, 1-hexene, 1-octene, 1-heptene, 4-methyl-pentene-1, 4-methyl-hexene-1 , 4,4-dimethylpentene-1, etc.; more preferred are 1-butene, 1-pentene, 1-hexene and 1-octene; even more preferred are 1-butene and 1-hexene. Preferably, the proportion of the propylene unit in the copolymer is from 80 mol % to less than 100 mol %, and that of the copolymer is from more than 0 to 20 mol %, from the viewpoint of the balance between the transparency and the heat resistance of the film. The α-olefin is not limited to only one type, but two or more different types thereof may be used here and the copolymer may be a polynary copolymer such as terpolymer. The content of the comonomer-derived constitutive unit in the copolymer may be determined through infrared (IR) absorption spectrometry.

Preferably, the polypropylene resin (A) for use in the present invention comprises a propylene copolymer produced through polymerization with a known polymerization catalyst such as Ziegler Natta catalyst, metallocene catalyst or the like, in consideration of the fact that the UV absorbent mixture hardly bleeds out in the film, and more preferably comprises a propylene polymer produced through polymerization with a metallocene catalyst from the viewpoint of more excellent transparency of the film. The propylene polymer produced through polymerization with a metallocene catalyst is generally characterized in that the molecular weight and the crystallinity thereof are uniform and the content of low-molecular low-crystalline ingredients therein is small. Therefore, when the propylene polymer of the type is used in forming an optical film, the film obtained may have high transparency and low birefringence.

### (Metallocene Catalyst)

As the metallocene catalyst, any known one is usable here. In general, usable are Group 4 to 6 transition metal compounds with Zr, Ti, Hf or the like, especially Group 4 transition metal compounds, and organic transition metal compounds having a cyclopentadienyl group or a group of cyclopentadienyl derivative.

As the group of cyclopentadienyl derivative, herein usable are alkyl-substituted groups such as pentamethylcyclopentadienyl group, or groups in which two or more substituents bond to each other to constitute a saturated or unsaturated cyclic substituent. Typically there may be mentioned an indenyl group, a fluorenyl group, an azulenyl group, or partially hydrogenated derivatives thereof. In addition, also preferably mentioned are those in which plural cyclopentadienyl groups are bonded to each other via an alkylene group, a silylene group, a germylene group or the like existing therebetween.

### (Catalyst Promoter)

In production of the propylene polymer, a catalyst promoter may be used along with the metallocene catalyst. As the catalyst promoter, herein usable is at least one selected from aluminiumoxy compounds, ionic compounds capable of reacting with a metallocene compound to convert the metallocene compound ingredient into a cation, Lewis acids, solid acids, and phyllosilicates. If desired, an organoaluminium compound may be added to the system along with any of these compounds.

### (Polymerization Method for Propylene Polymer Using Metallocene Catalyst)

As the method (polymerization method) for producing a propylene polymer by the use of the above-mentioned metallocene catalyst, there may be mentioned a slurry method using an inert solvent in the presence of the catalyst, a vapor phase method not substantially using a solvent, a solution method, a bulk polymerization method where the polymerizing monomer serves as the solvent, etc.

### (Physical Properties of Propylene Polymer)

The propylene polymer for use in the present invention preferably has a melting point (Tm) of from 120 to 170° C. When the melting point (Tm) falls within the above range, it is favorable since the heat resistance of the optical film is bettered and the film is applicable to use that requires heat resistance, such as polarizer, etc. In this, the melting point is evaluated as the temperature at which a maximum-intensity peak appears in the melting curve drawn through differential scanning calorimetry (DSC). Concretely, 10 mg of a press film of a propylene polymer is heat-treated in a nitrogen atmosphere at 230° C. for 5 minutes, then cooled down to 30° C. at a cooling rate of 10° C./min, kept at that temperature for 5 minutes, and thereafter further heated from 30° C. up to 230° C. at a heating rate of 10° C./min; and in the heating cycle, the melting peak temperature is the melting point of the tested polymer.

For obtaining an optical film having high optical isotropy, the propylene polymer preferably gives an in-plane retardation of at most 20 nm in the resin selection test mentioned below. In particular, a propylene random copolymer is preferred for use in the optical film of the present invention as the birefringence thereof is small.

### (Resin Selection Test)

Sample pellets are hot-pressed into a film having a size of 10 cm square and a thickness of 100 μm. In the hot-pressing, the resin is preheated at 220° C. for 5 minutes, then pressurized up to 100 kgf/cm², taking 3 minutes, kept under 100 kgf/cm² for 2 minutes, and thereafter cooled at 30° C. and under a pressure of 30 kgf/cm² for 5 minutes. Thus produced, the in-plane retardation of the film is measured, and the propylene copolymer having low birefringence can be thereby selected. The in-plane retardation is measured under the condition of a wavelength of 589.3 nm and an incident angle of 0 degree, using a retardation measuring machine.

Preferably, the propylene polymer has a melt flow rate (MFR) of from 0.5 to 50 g/10 min, more preferably at least 7 g/10 min. When MFR of the propylene polymer falls within the above range, then the unstretched film is hardly deformed during production thereof, and therefore an optical film having low birefringence can be obtained. In addition, the optical film can have sufficient strength and can be readily post-worked. Further, the amount to be added of the additive such as MFR-regulating agent can be reduced, and the additive does not have any negative influence on the physical properties of the film. For controlling MFR of the mixture, for example, an ordinary MFR-regulating agent such as organic peroxide or the like may be used here.

The value of MFR may be measured according to JIS K7210, under the condition of a temperature of 230° C. and a load of 21.18 N.

The molecular weight distribution width of the propylene polymer may be evaluated by the ratio of the weight-average molecular weight Mw to the number-average molecular weight Mn thereof (degree of dispersion), and preferably, Mw/Mn is from 1 to 20.

Mn and Mw are measured through gel permeation chromatography (GPC), under the condition of using a solvent of o-dichlorobenzene at 140° C. and using polystyrene as the standard sample.

### <<UV Absorbent Mixture>>

The polypropylene resin mixture for use in the present invention contains (B) a 2-(hydroxyphenyl)benzotriazole derivative 1 and (C) a 2-(hydroxyphenyl)benzotriazole derivative 2, wherein the 2-(hydroxyphenyl)benzotriazole derivative 2 (C) (UV absorbent (c)) is 2-(2-hydroxy-3-tert-butyl-5-methylphenyl)-5-chlorobenzotriazole (CAS No. 3896-11-5) represented by the following general formula (1).

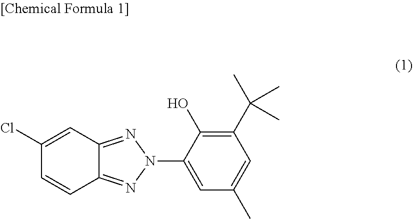

The polypropylene resin mixture for use in the present invention contains the 2-(hydroxyphenyl)benzotriazole derivative represented by the above-mentioned general formula (1), and is therefore given an effect of enhancing the UV absorbability thereof in a wavelength region of from 370 to 400 nm. In particular, when the benzene ring to form the benzotriazole skeleton in the derivative represented by the above-mentioned general formula (1) is substituted with a halogen atom, the effect of enhancing the UV absorbability in the wavelength region of from 370 to 400 nm is high.

The UV absorbent (B) is a 2-(hydroxyphenyl)benzotriazole derivative differing from the UV absorbent (C), and is not specifically defined so far as it is a 2-(hydroxyphenyl)benzotriazole derivative in which a phenol bonds to the benzotriazole skeleton thereof, for which, however, preferred are (i) those having a functional group with a tertiary carbon such as a tert-alkyl group or the like, for example, the derivatives represented by the following general formulae (2) to (5); (ii) those having an oxyalkyl group with from 1 to 10 or so carbon atoms, such as the derivative represented by the following general formula (6); (iii) those with a functional group having UV absorbability by itself, such as the derivative represented by the following general formula (7); (iv) dimers or trimers via a linking group, such as the derivative represented by the following general formula (5); (v) those in which the benzene ring to form the benzotriazole skeleton is substituted with a halogen atom, or with a hydrocarbon group such as an alkyl group or the like, for example, the derivative represented by the above-mentioned general formula (1), and the UV absorbents having any of those structures are preferably mentioned here since the effect of enhancing the UV absorbability thereof within a wavelength range of from 280 to 400 nm is high.

More concretely, the derivative represented by the following general formula (2) is 2-[2-hydroxy-5-(1,1,3,3-tetramethylbutyl)phenyl]benzotriazole (CAS No. 3147-75-9); the derivative represented by the following general formula (3) is 2-(2-hydroxy-3,5-di-tert-pentylphenyl)benzotriazole (CAS No. 25973-55-1); the derivative represented by the following general formula (4) is 2-[2-hydroxy-3,5-bis(α,α-dimethylbenzyl)phenyl]benzotriazole (CAS No. 70321-86-7); the derivative represented by the following general formula (5) is 2,2′-methylenebis[3-hydroxy-5-(1,1,3,3-tetramethylbutyl)phenyl]bis(benzotriazole) (CAS No. 103597-45-1); the derivative represented by the following general formula (6) is 2-(2-hydroxy-4-octyloxyphenyl)benzotriazole (CAS No. 3147-77-1); and the derivative represented by the following general formula (7) is 2-[2-hydroxy-3-[(1,3,4,5,6,7-hexahydro-1,3-dioxo-2H-isoindol-2-yl)methyl]-5-methylphenyl]benzotriazole (CAS No. 59129-18-9). Of those, preferred are 2-[2-hydroxy-5-(1,1,3,3-tetramethylbutyl)phenyl]benzotriazole represented by the following general formula (2), and 2-(2-hydroxy-3,5-di-tert-pentylphenyl)benzotriazole represented by the following general formula (3).

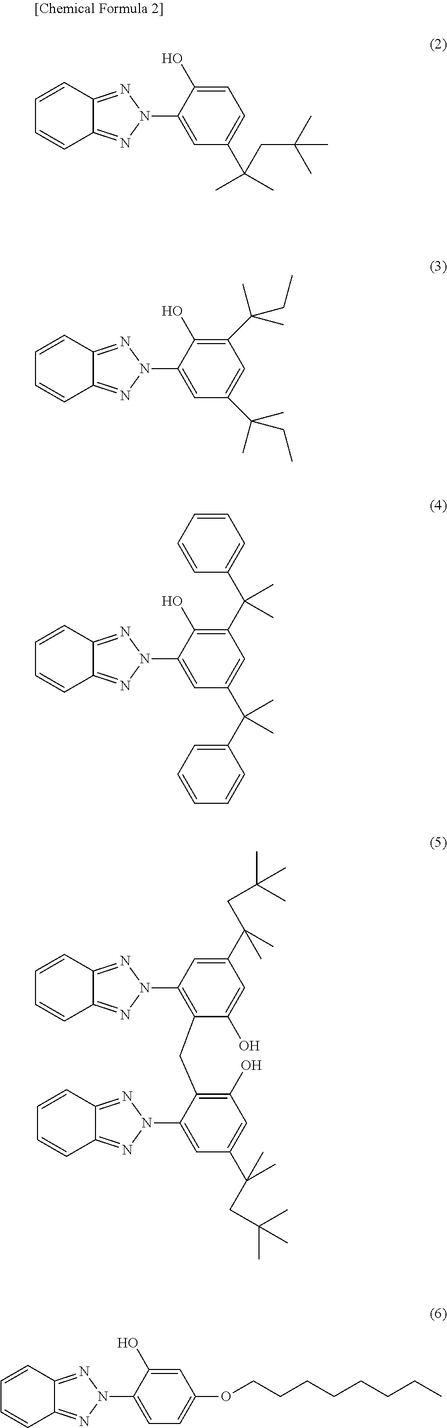

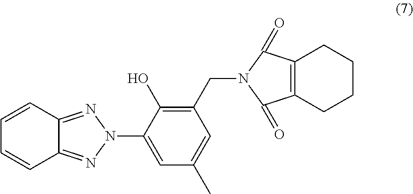

UV rays of optical energy are electromagnetic waves having a wavelength of at most 400 nm, and for preventing polarizer and liquid crystal cell from being deteriorated by UV rays, in particular, it is necessary to shield against UV rays falling within a wavelength range of from 280 to 400 nm by a polarizer-protective film. The UV absorbent (B) and the UV absorbent (C) for use in the present invention are both excellent benzotriazole-type UV absorbents; however, the UV absorbent (C) may readily bleed out and may detract from the transparency and the processing aptitude of the film, as the case may be, and the UV absorbent (B) is not sufficient in point of the UV absorbability thereof in a wavelength region of from 370 to 400 nm in some cases. In the present invention, it has been fount that use of these UV absorbents as combined in a predetermined ratio attains an excellent UV absorbability in a wavelength region of from 370 to 400 nm and provides an excellent effect of preventing the absorbents from bleeding out.

### (Content Ratio of UV Absorbent (C))

In the present invention, the content ratio of the UV absorbent (C) must be from 8 to 60% by mass relative to the total amount of the UV absorbents (B) and (C). When the content ratio of the UV absorbent (C) is more than the above range, then the absorbent bleeds out in production of the optical film, thereby detracting from the transparency and the processing aptitude of the film. On the other hand, when the content of the UV absorbent (C) is less than the above range, then the UV absorbability may be poor in the wavelength region of from 280 to 400 nm, especially in the wavelength region of from 370 to 400 nm. From these viewpoints, the content ratio of the LTV absorbent (C) is preferably from 20 to 60% by mass, more preferably from 40 to 60% by mass

### (Total Content of UV Absorbents (B) and (C))

In the present invention, the lowermost limit of the total content of the UV absorbents (B) and (C) in the polypropylene resin mixture is preferably at least 0.08% by mass relative to the mixture. From the viewpoint of attaining a good UV absorbability, the total content is preferably at least 0.3% by mass, more preferably at least 0.4% by mass.

On the other hand, the uppermost limit of the total content of the UV absorbents (B) and (C) in the polypropylene resin mixture is preferably at most 5.5% by mass relative to the mixture from the viewpoint of preventing the UV absorbents from bleeding out in formation and processing of the film. In addition, from the viewpoint of the cost, the total content is more preferably at most 1.5% by mass relative to the mixture, even more preferably at most 1.2% by mass.

From the above, for obtaining a high-quality optical film, the total content of the UV absorbents (B) and (C) in the polypropylene resin mixture is preferably from 0.08 to 5.5% by mass, more preferably from 0.3 to 1.5% by mass, even more preferably from 0.4 to 1.2% by mass.

### <<Other Ingredients>>

In the present invention, if desired, various additives and additive resins may be optionally added to the polypropylene resin mixture as optional ingredients therein.

For example, depending on the desired physical properties of the film, any other various types of olefin resins than polypropylene produced through polymerization with a metallocene catalyst may be incorporated in the resin mixture as additive resins, within a range not detracting from the birefringence and transparency necessary for retardation films; and weather resistance improver, light stabilizer, abrasion resistance improver, polymerization inhibitor, crosslinking agent, IR absorbent, antistatic agent, adhesiveness improver, leveling agent, thixotropy-imparting agent, coupling agent, plasticizer, defoaming agent, filler, solvent and the like may be added thereto.

### <<Optical Film>>

The optical film of the present invention is an optical film to be formed of the above-mentioned polypropylene resin mixture. The thickness of the optical film of the present invention is preferably within a range of from 35 to 160 μm, more preferably from 60 to 120 μm.

It is known that, in case where UV absorbents having the same degree of absorbency are used in a film, the UV absorbability of the film is proportional to the thickness of the film according to the Lambert-Beer law represented by the following numerical formula:

−log(I/IO)=ε×c×d

wherein IO is the intensity of the incident light; I is the intensity of the transmitted light; −log(I/IO) is the absorbance; ε is the absorption coefficient; c is the concentration of the substance; and d is the thickness of the absorbent substance. As known from the formula, when the thickness of the optical film falls within the above range, then it is favorable since the film can have excellent UV absorbability and its transparency does not lower. When the thickness is 35 μm or more, then the optical film can secure the strength thereof. When the thickness is at most 160 μm, then the film secures sufficient flexibility and the weight thereof is light, and the film can be handled with ease and is advantageous in point of the cost thereof.

Preferably, the bending elastic modulus of the optical film of the present invention is at least 700 MPa. When the bending elastic modulus falls within the above range, then the film secures a sufficient toughness when handled in the form of a film, and can be readily post-worked, and in addition, the film can secure a sufficient degree of abrasion resistance when made to function as a protective sheet for polarizing plates. Further, the bending elastic modulus of the optical film of the present invention is more preferably at least 900 MPa. When the modulus is at least 900 MPa, the in-plane retardation of the film can be stabilized when the film is produced through T-die extrusion. The bending elastic modulus is measured according to JIS K7171.

The method of controlling the bending elastic modulus of the optical film is not specifically defined, and the modulus can be controlled according to the method mentioned below. For example, herein employable are a method of selecting the resin depending on the intrinsic characteristics of polypropylene (degree of crystallinity, mean molecular weight, etc.); a method of adding a filler selected from inorganic or organic fillers to the resin; a method of adding a crosslinking agent thereto; a method of mixing at least two types of resins differing in the modulus of elasticity thereof; a method of selecting the plasticizer ingredient for the curable resin. These methods may be suitably combined in any desired manner.

Preferably, the tensile strength of the optical film is at least 20 MPa. When the strength is at least 20 MPa, then any orientation is not given to the film in the process of processing it to give a polarizer-protective film, in which the optical film is stuck to a polarizer via an adhesive layer according to a roll-to-roll process, and therefore the retardation in the formed film fluctuates little and the performance of the polarizing plate can be bettered. In the present invention, the tensile strength is measured according to ASTM D638 (Condition Type 4).

The optical film of the present invention may be processed for easy adhesion treatment for enhancing the adhesiveness of the surface thereof to face polarizer. For the easy adhesion treatment, there may be mentioned a method of corona treatment, plasma treatment, a low-pressure UV treatment, or a saponification treatment or the like surface treatment, as well as a method of forming an anchor layer. These methods may be combined here. Of those, preferred is a method of corona treatment, a method of forming an anchor layer, or a combination of these methods.

Functional layers may be laminated on the surface of the optical film, whereby various functions may be given to the film. For example, the functions include hard coat function of having high hardness and having scratching resistance, antifogging coat function, antifouling coat function, antiglare coat function, antireflection coat function, UV-blocking coat function, IR-blocking coat function, etc.

### <<Method for Producing Optical Film>>

The optical film of the present invention can be produced by mixing the above-mentioned polypropylene resin (A), UV absorbents (B) and (C) and various optional additives and additive resins, melting them under heat and thereafter shaping the melt into films according to an extrusion coating and shaping method, a casting method, a T-die extrusion shaping method, a water-cooling inflation method, an air-cooling inflation method, an injection molding method or the like. In the present invention, it is desirable that the optical film to be arranged on a polarizer is not oriented; and therefore, an unstretched T-die extrusion shaping method with no stretching, or an inflation method is preferred.

The heating temperature during processing generally falls within a range of from 160 to 250° C., preferably from 190 to 250° C. When the heating temperature falls within the above range, then an optical film with more excellent performance stability can be obtained.

Thus obtained, the optical film of the present invention is excellent in optical characteristics and UV absorbability and is excellent in outward appearance in which the UV absorbent does not bleed out; and therefore the film is especially favorably used as an optical film for polarizer protection.

### [Polarizing Plate]

The optical film of the present invention can be arranged on at least one surface of a polarizer, and is thus used as a polarizer-protective film. For the method of arranging the optical film on a polarizer, there may be mentioned a method of directly forming the polarizer-protective optical film on a polarizer, and a method where the polarizer-protective optical film is first formed and thereafter the film is stuck to a polarizer via an adhesive layer therebetween; and any of these methods is employable here.

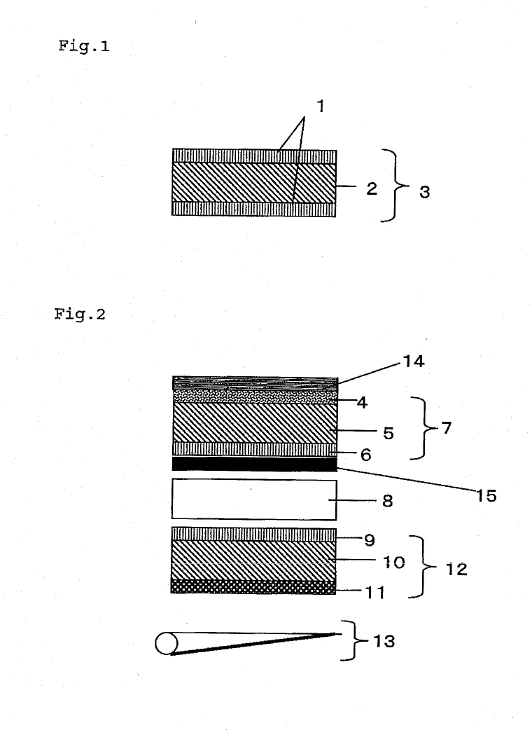

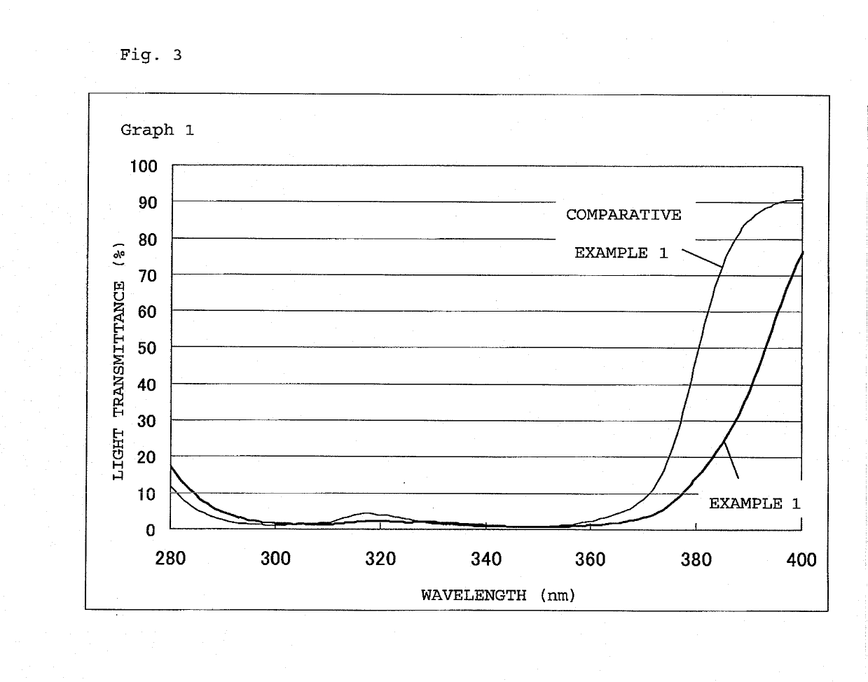

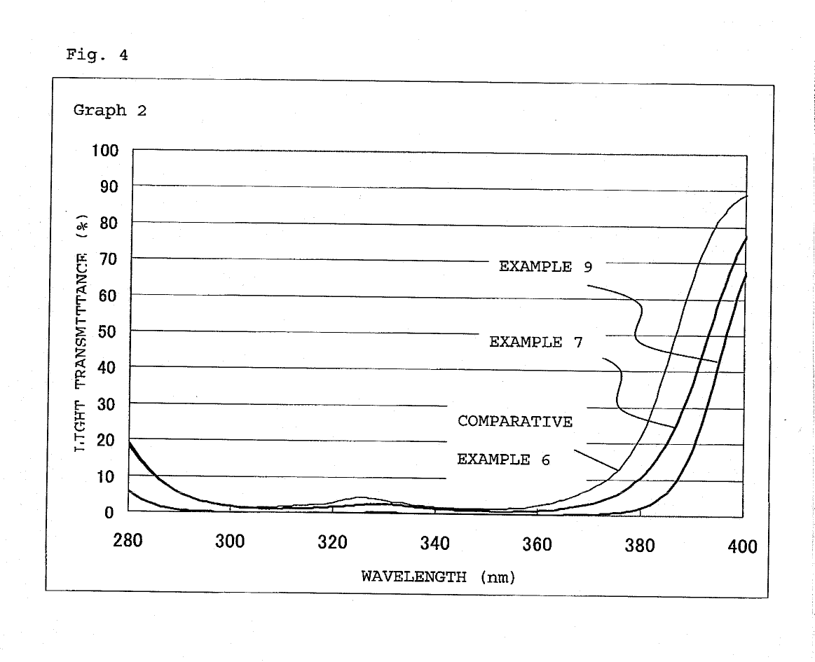

FIG. 1 shows a configuration example of the polarizing plate of the present invention. In FIG. 1, 2 is a polarizer, and the optical film 1 of the present invention is arranged on one side thereof via an adhesive layer (not shown), therefore constituting the polarizing plate 3 as a whole. The polarizing plate of the present invention is used in a liquid crystal display device, and may be so designed that the optical film of the present invention is provided on the backlight side of the device, as described hereinunder.

### <<Polarizer>>

The polarizer for use in the polarizing plate may be any and every polarizer having a function of transmitting only a light having a specific vibration direction, and in general, a PVA polarizer is favorably used here.

As the PVA polarizer, for example, there may be mentioned one produced by making a hydrophilic polymer film, such as a PVA film, a partially-formulated polyvinyl alcohol film, an ethylene/vinyl acetate copolymer-partially saponified film or the like, adsorb a dichroic substance such as iodine or a dichroic dye followed by monoaxially stretching the film. Of those, favorably used here is a polarizer formed of a PVA film and a dichroic substance such as iodine or the like. Not specifically defined, the thickness of the polarizer may be generally from 1 to 100 μm or so.

### <<Method for Producing Polarizing Plate>>

The polarizing plate may be produced according to a method comprising a step of monoaxially stretching the above-mentioned PVA film, a step of dyeing the PVA resin film with a dichroic dye to thereby make the film adsorb the dichroic dye, a step of processing the dichroic dye-adsorbed PVA film with an aqueous boric acid solution, a step of washing the film after processed with the aqueous boric acid solution, with water, and a step of sticking the polarizer-protective optical film to the monoaxially-stretched PVA film thus processed for dichroic dye adsorption and orientation through the process as above.

The polarizer-protective optical film may be stuck via the adhesive layer provided by coating on any one side or both sides of the polarizer-protective film or the polarizer. For forming the adhesive layer, preferred is use of a known PVA adhesive.

The adhesive layer is formed on any one side or both sides of the polarizer-protective film or the polarizer, by applying the adhesive thereto. Regarding the thickness of the adhesive layer, when the layer is too thick after dried, the thick layer is unfavorable from the viewpoint of the adhesiveness of the polarizer-protective film; and therefore, the thickness is preferably from 0.01 to 10 μm, more preferably from 0.03 to 5 μm.

In adhering the polarizer-protective film to the polarizer, the surface of the polarizer-protective film to face the polarizer may be processed for easy adhesion treatment according to a method of surface treatment of corona treatment, plasma treatment, low-pressure UV treatment, saponification treatment or the like or a method of forming an anchor layer or the like. Above all, a method of corona discharge treatment or a method anchor layer formation, or a combination of the two methods is preferred.

Next, an adhesive layer is formed on the surface that has been processed for easy adhesion treatment as above, and the polarizer and the polarizer protective film are stuck together via the adhesive layer therebetween.

The polarizer and the polarizer-protective film may be stuck together, using a roll laminator. The heating and drying temperature and the drying time may be suitably determined depending on the type of the adhesive.

On the polarizing plate having the optical film of the present invention formed on one side of the polarizer therein, if desired, the optical film of the present invention may be further formed on the other surface of the polarizer, or a film of any other resin may be formed thereon. The film of the other resin includes, for example, cellulose film, polyethylene terephthalate film, polycarbonate film, cyclic polyolefin film, maleimide resin film, fluororesin film, etc. Above all, it is known that a cellulose triacetate or the like cellulose film has a high water vapor permeability and therefore moisture may readily penetrate therethrough, and on the other hand, the optical film comprising polypropylene resin of the present invention has a low water vapor permeability and moisture could hardly penetrate therethrough. Accordingly, when a cellulose film is stuck to the other surface of the polarizer, then it is favorable since moisture removal in the drying step of producing the polarizing plate could be easy. The film of the other resin may be a retardation film having a specific retardation level.

Preferably, the polarizing plate is in the form of a laminate having at least one hard coat layer or antireflection layer formed on the polarizer-protective film, for enhancing the surface property and the scratching resistance thereof, and if desired, for giving any known antiglare function such as antireflection or reflection reduction thereto. In this case, the order in lamination of the hard coat layer and the antireflection layer on the polarizer-protective film.

The laminate may be produced by forming a hard coat layer or an antireflection layer on the polarizer-protective film. As the hard coat layer and the antireflection layer, there may be mentioned a hard coat layer formed of a UV-curable resin such as UV-curable acrylurethane, UV-curable epoxy acrylate, UV-curable (poly) ester acrylate, UV-curable oxetane, etc.; or a silicone resin, acrylic resin, urethane hard coat layer, etc. From the viewpoint of transparency, scratch resistance and chemical resistance, preferred is one formed of a UV-curable resin. One or more different types of these hard coat layer and antireflection layer may be used here.

Preferably, the thickness of the hard coat layer and the antireflection layer is from 0.1 to 100 μm each, more preferably from 1 to 50 μm, even more preferably from 2 to 20 μm. The surface below the hard coat layer or the antireflection layer may be processed for primer treatment.

The laminate may be produced by laminating a hard coat film or an antireflection film on the polarizer-protective film. The hard coat film or the antireflection film may be formed, for example, by providing the above-mentioned hard coat layer or antireflection layer on a UV absorbent-free polyethylene terephthalate (PET) film.

### [Image Display Device]

The polarizing plate comprising the optical film of the present invention can be favorably used in various display devices. The type of the image display device is not specifically defined so far as the device has a polarizing plate, and for example, there may be mentioned a liquid crystal display device containing a liquid crystal cell, as well as an organic EL display device, a touch panel, etc. Above all, for making full use of the characteristics of the optical film of the present invention, the polarizing plate comprising the optical film is preferably used in a liquid crystal display device. A liquid crystal display device for image display is generally constructed by suitably assembling the constitutive members of a liquid crystal cell, an optical film and optionally lighting systems and others followed by incorporating driving circuit thereinto; and in the present invention, the constitution of the image display device is not specifically defined except that the above-mentioned polarizing plate is used therein. For example, there may be mentioned an image display device in which the polarizing plate is arranged on one side or on both sides of the liquid crystal cell therein, an image display device comprising a backlight or a reflector plate in the lighting system, etc. As the liquid crystal cell, various types of cells such as TN-mode, STN-mode, π-mode or the like cells are employable here. In constituting the image display device, for example, suitable members such as a diffuser, an antiglare layer, an antireflection film, a protective film, a prism array, a lens array sheet, a light diffuser, a backlight or the like may be arranged in any desired sites as one or more layers thereof.

An example of a liquid crystal display device containing a liquid crystal cell is described below.

### <<Liquid Crystal Display Device Containing Liquid Crystal Cell>>

The liquid crystal display device of the present invention is characterized in that a polarizer is used therein, the optical film of the present invention is arranged on the backlight side of the polarizer, and the backlight is a fluorescent tube. As one example of the image display device of the present invention, FIG. 2 shows one embodiment of a preferred configuration example of the liquid crystal display device of the present invention that comprises the polarizing plate of the present invention, or that is, a polarizing plate having the optical film of the present invention on at least one side of the polarizer therein. In FIG. 2, 8 is a liquid crystal cell. Examples of the liquid crystal cell 8 include an active matrix drive-type cell such as typically a thin-film transistor-type cell, etc.; and a simple matrix drive-type cell such as typically a twist nematic-type or super twist nematic-type cell, etc. On one side of the liquid crystal cell 8, laminated is the upper polarizing plate 7 (upper-side polarizing plate relative to the liquid crystal cell) via the adhesive layer (not shown) and the retardation film 15; and on the other side of the liquid crystal cell 8, laminated is the lower polarizing plate 12 (backlight-side polarizing plate relative to the liquid crystal cell). The upper polarizing plate 7 has the polarizer 5 at the center thereof, and the polarizer-protective films 4 and 6 are laminated on both sides of the polarizer 5. The lower polarizing plate 12 has the polarizer 10 at the center thereof, and the polarizer-protective films 9 and 11 are laminated on both sides of the polarizer 10. In the configuration example shown in FIG. 2, the antireflection layer (or antireflection film) 14 is further arranged on the polarizer-protective film 4 arranged on the upper polarizing plate on the upper panel side thereof.

The optical film of the present invention may be used as any of the polarizer-protective films 4, 6, 9 and 11, but is preferably used as the polarizer-protective films 4 and 11. This is because, when used as the polarizer-protective film 4, the optical film can block the UV rays of sunlight and the external light (light from the outside of the liquid crystal display device); and when used as the polarizer-protective film 11, the optical film can block the UV rays from the backlight. From the viewpoint making full use of the performance thereof, the optical film of the present invention is preferably used in a liquid crystal display device where a fluorescent tube is used as the backlight therein. A fluorescent tube emits a large quantity of UV rays, and therefore in the case, the excellent UV absorbability of the optical film of the present invention is effective.

In lamination of the upper polarizing plate 7 or the lower polarizing plate 12 and the liquid crystal cell 8, an adhesive layer may be previously arranged on the upper polarizing plate 7, the lower polarizing plate 12 or the liquid crystal cell 6. The adhesive layer to be used here is not specifically defined, for which, for example, preferably mentioned is an acrylic adhesive as excellent in the optical transparency, showing suitable adhesive characteristics of wettability, cohesiveness and adhesiveness, and excellent in weather resistance, heat resistance, etc.

The adhesive is required to be excellent in optical transparency and suitable adhesive characteristics of wettability, cohesiveness and adhesiveness, and excellent in weather resistance, heat resistance, etc. Further, from the viewpoint of preventing foaming phenomenon and peeling phenomenon owing to moisture absorption, preventing degradation of the optical characteristics and deformation of the liquid crystal cell owing to thermal expansion difference, and securing formability of liquid crystal display devices having high quality and excellent in durability, the adhesive layer is required to have a low moisture absorption and to be excellent in heat resistance.

The adhesive may be applied to the polarizing plate, for example, according to a method comprising preparing an adhesive solution having a concentration of from 10 to 40% by mass or so by dissolving or dispersing the base polymer or its composition in a suitable single solvent of toluene, ethyl acetate or the like or a mixture thereof, followed by directly applying it onto the polarizing plate according to a suitable spreading method, for example, a coating method of gravure coating, bar coating, roll coating or the like or a casting method or the like; or according to a method comprising forming an adhesive layer on a releasable base film according to the above-mentioned method followed by transferring the layer onto the polarizing plate.

The adhesive layer may be a laminate layer of adhesives of the same or different composition, and may be arranged on one side or on both sides of the polarizing plate. In case where the layer is arranged on both sides of the polarizing plate, it is not necessary that the adhesive is the same both on the surface and the back of the polarizing plate, and it is not also necessary that the adhesive layer has the same thickness both on the two. The adhesive layer may have a different composition and have a different thickness.

The thickness of the adhesive layer may be suitably determined depending on the intended use and the adhesion power thereof, and in general, may be from 1 μm to 500 μm, preferably from 5 μm to 200 μm, more preferably from 10 μm to 100 μm.

Before used in practice, preferably, the exposed surface of the adhesive layer is covered with a releasable film prepared by optionally coating a suitable sheetwise-cut plastic film or the like with a silicone-type or the like suitable release agent, for the purpose of preventing its contamination. Accordingly, the adhesive layer can be protected from direct touch in ordinary handling condition.

### EXAMPLES

The present invention is described in more detail with reference to the following Examples, by which, however, the present invention is not whatsoever limited.

### (Evaluation Methods)

### (1) Evaluation of UV Absorbability:

Using a UV-visible light absorption spectrometer (Shimadzu's “Model UV-2400”), the light transmittance of the optical film was measured at a wavelength of 280 nm, 330 nm, 370 nm, 375 nm, 380 nm, 385 nm, 390 nm, 395 nm and 400 nm. In Examples 1 to 6 and Comparative Examples 2 to 5, the light transmittance of the sample was expressed as an index based on the light transmittance, 100 of the sample in Comparative Example 1, according to the following formula (1). In Examples 7 to 12 and Comparative Examples 7 to 9, the light transmittance was expressed as an index based on the light transmittance, 100 in Comparative Example 6, according to the following formula (ii). The samples having a smaller index have better UV absorbability; and concretely, the samples having an index of at most 90 were considered good.

UV Absorbability Index=(UV transmittance in Examples 1 to 6 and Comparative Examples 2 to 5/UV transmittance in Comparative Example 1)×100 (i)

UV Absorbability Index=(UV transmittance in Examples 7 to 12 and Comparative Examples 7 to 9/UV transmittance in Comparative Example 6)×100 (ii)

### (2) Evaluation of UV Absorbability at Wavelength 380 nm:

The UV absorbability at a wavelength of 380 nm, as determined in the above (1), was evaluated according to the following standards.

A: UV transmittance was less than 10%.
B: UV transmittance was from 10% to less than 40%.
C: UV transmittance was at least 40%.

### (3) Evaluation of Haze:

The haze of the optical film obtained in Examples and Comparative Examples was measured according to JIS K7105, and evaluated according to the following standards.

A: Haze is less than 5%.
B: Haze is from 5% to less than 10%.
C: Haze is at least 10%.

### (4) Evaluation of Visible Light Transmittance:

Using a UV-visible light absorption spectrometer (Shimadzu's “Model UV-2400”), the light transmittance of the optical film was measured at a wavelength of 550 nm and 750 nm, and evaluated according to the following standards.

A: Light transmittance is from 90% to 100%.
B: Light transmittance is from 80% to less than 90%.
C: Light transmittance is less than 80%.

### (5) Evaluation of Outward Appearance (Bleeding Out):

The formed optical film was left under a condition 1, temperature 80° C. and relative humidity 10 to 40% (dry condition), or a condition 2, temperature 60° C. and relative humidity 90%, for 1000 hours. After left under the condition 1 or 2, the optical film was visually checked for the outward appearance (presence of absence of bleeding out of ITV absorbent), and evaluated according to the following standards.

A: No appearance failure owing to whitening through bleeding out was seen.
B: Some appearance failure owing to whitening through bleeding out was seen, but was not problematic in practical use.
C: Appearance failure owing to whitening through extreme bleeding out was seen.

### Example 1

0.25 part by mass of 2-[2-hydroxy-5-(1,1,3,3-tetramethylbutyl)phenyl]benzotriazole (BASF's TINUVIN 329 (trade name)—hereinafter expressed as “UV-B1”) and 0.25 part by mass of 2-(2-hydroxy-3-tert-butyl-5-methylphenyl)-5-chlorobenzotriazole (BASF's TINUVIN 326 (trade name)—hereinafter expressed as “UV-C”) were added to 99.5 parts by mass of a propylene copolymer (propylene copolymer produced through polymerization with a metallocene catalyst (Nippon Polypro's Wintec® having a bending elastic modulus of 900 MPa, a melting point of 142° C. and MFR of 30 g/10 min—hereinafter expressed as “PP-A”) and mixed to prepare a polypropylene resin mixture, which was then melted under heat. Under the condition at a processing temperature of 200° C. and a take-out roll temperature of 50° C., the resin mixture was shaped by extrusion through a T-die into a single-layer film having a thickness of 80 μm, thereby giving an optical film.

### Example 2

An optical film was produced in the same manner as in Example 1, except that PP-A in Example 1 was changed to a propylene copolymer (propylene copolymer produced with a Ziegler-Natta catalyst (Primer Polymer's J-3021GR (trade name) having a bending elastic modulus of 1000 MPa, a melting point of 150° C. and MFR of 33 g/10 min—hereinafter expressed as “PP-B”).

### Example 3

An optical film was produced in the same manner as in Example 1, except that the amount of PP-A in Example 1 was changed to 99 parts by mass and the amount of UV-B1 and UV-C was to 0.5 part by mass each.

### Example 4

An optical film was produced in the same manner as in Example 1, except that the amount of PP-A in Example 1 was changed to 99 parts by mass, the amount of UV-B1 was to 0.9 part by mass and the amount of UV-C was to 0.1 part by mass each.

### Example 5

An optical film was produced in the same manner as in Example 1, except that the amount of PP-A in Example 1 was changed to 99 parts by mass, the amount of UV-B1 and UV-C was to 0.5 part by mass each and the thickness of the optical film was changed to 40

### Example 6

An optical film was produced in the same manner as in Example 1, except that the amount of PP-A in Example 1 was changed to 99.5 parts by mass, the amount of UV-B1 and UV-C was to 0.25 part by mass each and the thickness of the optical film was changed to 150 μm.

### Comparative Example 1

An optical film was produced in the same manner as in Example 1, except that the amount of PP-A in Example 1 was changed to 99.5 parts by mass, the amount of UV-B1 was to 0.5 part by mass and UV-C was not used.

### Comparative Example 2

An optical film was produced in the same manner as in Example 1, except that the amount of PP-A in Example 1 was changed to 99 parts by mass, the amount of UV-B1 was to 1 part by mass and UV-C was not used.

### Comparative Example 3

An optical film was produced in the same manner as in Example 1, except that the amount of PP-A in Example 1 was changed to 99 parts by mass, the amount of UV-C was to 1 part by mass and UV-B1 was not used.

### Comparative Example 4

An optical film was produced in the same manner as in Example 1, except that the amount of PP-A in Example 1 was changed to 99 parts by mass, the amount of UV-B1 was to 0.95 part by mass and the amount of UV-C was to 0.05 part by mass.

### Comparative Example 5

An optical film was produced in the same manner as in Example 1, except that the amount of PP-A in Example 1 was changed to 99 parts by mass, the amount of UV-B1 was to 0.2 part by mass and the amount of UV-C was to 0.8 part by mass.

### Example 7

An optical film was produced in the same manner as in Example 1, except that UV-B1 in Example 1 was changed to 2-(2-hydroxy-3,5-di-tert-pentylphenyl)benzotriazole (BASF's TINUVIN 328 (trade name)—hereinafter expressed as “UV-B2”).

### Example 8

An optical film was produced in the same manner as in Example 7, except that PP-A in Example 7 was changed to PP-B.

### Example 9

An optical film was produced in the same manner as in Example 7, except that the amount of PP-A in Example 7 was changed to 99 parts by mass and the amount of UV-B2 and UV-C was to 0.5 part by mass each.

### Example 10

An optical film was produced in the same manner as in Example 7, except that the amount of PP-A in Example 7 was changed to 99 parts by mass, the amount of UV-B2 was to 0.9 part by mass and the amount of UV-C was to 0.1 part by mass.

### Example 11

An optical film was produced in the same manner as in Example 7, except that the amount of PP-A in Example 7 was changed to 99 parts by mass, the amount of UV-B2 and UV-C was to 0.5 part by mass each, and the thickness of the optical film was changed to 40

### Example 12

An optical film was produced in the same manner as in Example 7, except that the amount of PP-A in Example 7 was changed to 99.5 parts by mass, the amount of UV-B2 and UV-C was to 0.25 part by mass each, and the thickness of the optical film was changed to 150 μm.

### Comparative Example 6

An optical film was produced in the same manner as in Example 7, except that the amount of PP-A in Example 7 was changed to 99.5 parts by mass, the amount of UV-B2 was to 0.5 part by mass and UV-C was not used.

### Comparative Example 7

An optical film was produced in the same manner as in Example 7, except that the amount of PP-A in Example 7 was changed to 99 parts by mass, the amount of UV-B2 was to 1 part by mass and UV-C was not used.

### Comparative Example 8

An optical film was produced in the same manner as in Example 7, except that the amount of PP-A in Example 7 was changed to 99 parts by mass, the amount of UV-B2 was to 0.95 part by mass and the amount of UV-C was to 0.05 part by mass.

### Comparative Example 9

An optical film was produced in the same manner as in Example 7, except that the amount of PP-A in Example 7 was changed to 99 parts by mass, the amount of UV-B2 was to 0.2 part by mass and the amount of UV-C was to 0.8 part by mass.

Table 1-1 and Table 2-1 show the evaluation results of the optical films obtained in Examples 1 to 6 and Comparative Examples 1 to 5. Table 1-2 and Table 2-2 show the evaluation results of the optical films obtained in Examples 7 to 12 and Comparative Examples 6 to 9.

The polarizer-protective optical films of Examples 1 to showed excellent performance in haze evaluation, transparency evaluation and outward appearance evaluation in addition to showing excellent UV absorbability, as using a polypropylene resin mixture prepared by mixing the UV absorbents (B) and (C) in the polypropylene resin (A) in a predetermined ratio. In Examples 1, 2 and 5, the light transmittance was over that in Comparative Example 1 at a wavelength of 280 nm, however, the light transmittance was not higher than 20% in every case, and it may be said that the optical films have an excellent performance. It has been confirmed that the polarizer-protective films of Examples 7 to 12 in which UV-B2 (2-(2-hydroxy-3,5-di-tert-pentylphenyl)benzotriazole) was used as the UV absorbent (B) were, as a whole, more excellent in the outward appearance evaluation thereof than the optical films of Examples 1 to 6 where UV-B1 (2-[2-hydroxy-5-(1,1,3,3-tetramethylbutyl)phenyl]benzotriazole) was used as the UV absorbent (B); or that is, the UV absorbent hardly bled out from the former optical films.

On the other hand, in Comparative Examples 1, 2, 6 and 7 where UV-C (UV absorbent (C)) was not used, the optical films were not sufficient in point of the UV absorbability in the wavelength region of from 375 to 400 nm, from 385 to 400 nm, from 385 to 400 nm and from 390 to 400 nm; and in Comparative Examples 4 and 8 where the content of UV-C (UV absorbent (C)) was small, the optical films were not sufficient in point of the UV absorbability in the wavelength region of from 385 to 400 nm and from 390 to 400 nm. In Comparative Example 3 where UV-B1 (UV absorbent (B)) was not used but UV-C (UV absorbent (C)) was used alone, in Comparative Example 5 where the content of UV-B1 (UV absorbent (B)) was small and in Comparative Example 9 where the content of UV-B2 (UV absorbent (B)) was small, the appearance failure of the samples owing to whitening through bleeding out was remarkable.

Graph 1 shows the light transmittance of the optical film of Example 1 and the optical film of Comparative Example 1; Graph 2 shows the light transmittance of the optical films of Examples 7 and 9 and Comparative Example 6. From the data of Graphs 1 and 2, the effect of enhancing the UV absorbability especially in a wavelength of from 370 to 400 nm is confirmed by the combination of the UV absorbents (B) and (C).

TABLE 1-1

| | | | | Light Transmittance at Different Wavelength | | | | | | | | |
|---|---|---|---|---|---|---|---|---|---|---|---|---|
| | | | | (upper row: UV absorbability index, middle row: found data of | | | | | | | | |
| | Thickness | Material | Content | light transmittance, lower row: UV absorbability at 380 nm) | | | | | | | | |
| | μm | Used | mas. pt. | 280 | 330 | 370 | 375 | 380 | 385 | 390 | 395 | 400 |
| Example 1 | 80 | PP-A | 99.5 | 146 | 27 | 41 | 40 | 31 | 33 | 46 | 76 | 84 |
| | | UV-B1 | 0.25 | 17.2 | 2.2 | 3.4 | 8.1 | 14.5 | 23.9 | 38.9 | 58.1 | 76.2 |
| | | UV-C | 0.25 | — | — | — | — | B | — | — | — | — |
| Example 2 | 80 | PP-B | 99.5 | 151 | 23 | 18 | 34 | 39 | 42 | 48 | 64 | 85 |
| | | UV-B1 | 0.25 | 17.8 | 1.9 | 1.5 | 6.8 | 18.5 | 30.5 | 41.0 | 57.8 | 77.5 |
| | | UV-C | 0.25 | — | — | — | — | B | — | — | — | — |
| Example 3 | 80 | PP-A | 99.0 | 66 | 12 | 14 | 10 | 15 | 17 | 26 | 50 | 74 |
| | | UV-B1 | 0.5 | 7.8 | 1.0 | 1.2 | 2.1 | 7.1 | 12.2 | 22.0 | 45.0 | 67.0 |
| | | UV-C | 0.5 | — | — | — | — | A | — | — | — | — |
| Example 4 | 80 | PP-A | 99.0 | 16 | 11 | 25 | 19 | 45 | 53 | 60 | 67 | 87 |
| | | UV-B1 | 0.9 | 1.9 | 0.9 | 2.1 | 3.9 | 21.2 | 39.0 | 51.2 | 59.8 | 79.5 |
| | | UV-C | 0.1 | — | — | — | — | B | — | — | — | — |
| Example 5 | 40 | PP-A | 99.0 | 160 | 59 | 66 | 42 | 31 | 34 | 50 | 70 | 87 |
| | | UV-B1 | 0.5 | 18.9 | 4.8 | 5.5 | 8.4 | 14.5 | 25.0 | 42.3 | 63.1 | 78.9 |
| | | UV-C | 0.5 | — | — | — | — | B | — | — | — | — |
| Example 6 | 150 | PP-A | 99.5 | 10 | 10 | 6 | 2 | 4 | 5 | 8 | 21 | 50 |
| | | UV-B1 | 0.25 | 1.2 | 0.8 | 0.5 | 0.5 | 3.0 | 4.6 | 7.2 | 18.5 | 45.4 |
| | | UV-C | 0.25 | — | — | — | — | A | — | — | — | — |
| Comparative | 80 | PP-A | 99.5 | 100 | 100 | 100 | 100 | 100 | 100 | 100 | 100 | 100 |
| Example 1 | | UV-B1 | 0.5 | 11.8 | 8.1 | 8.3 | 20.2 | 47.5 | 73.0 | 85.3 | 89.7 | 90.9 |
| | | UV-C | 0 | — | — | — | — | C | — | — | — | — |
| Comparative | 80 | PP-A | 99.0 | 14 | 9 | 8 | 21 | 49 | 75 | 90 | 96 | 98 |
| Example 2 | | UV-B1 | 1 | 1.7 | 0.7 | 0.7 | 4.3 | 23.2 | 55.1 | 77.1 | 86.1 | 89.4 |
| | | UV-C | 0 | — | — | — | — | B | — | — | — | — |
| Comparative | 80 | PP-A | 99.0 | 49 | 1 | 1 | 0 | 0 | 1 | 4 | 16 | 45 |
| Example 3 | | UV-B1 | 0 | 5.8 | 0.1 | 0.1 | 0.1 | 0.2 | 0.6 | 3.0 | 14.7 | 40.7 |
| | | UV-C | 1 | — | — | — | — | A | — | — | — | — |
| Comparative | 80 | PP-A | 99.0 | 15 | 9 | 6 | 19 | 47 | 66 | 82 | 85 | 94 |
| Example 4 | | UV-B1 | 0.95 | 1.8 | 0.7 | 0.5 | 3.9 | 22.1 | 48.4 | 70.2 | 75.9 | 85.9 |
| | | UV-C | 0.05 | — | — | — | — | B | — | — | — | — |
| Comparative | 80 | PP-A | 99.0 | 42 | 6 | 24 | 10 | 11 | 9 | 9 | 29 | 56 |
| Example 5 | | UV-B1 | 0.2 | 5.0 | 0.5 | 2.0 | 2.0 | 5.4 | 6.7 | 8.0 | 25.6 | 50.8 |
| | | UV-C | 0.8 | — | — | — | — | A | — | — | — | — |

TABLE 1-2

| | | | | Light Transmittance at Different Wavelength | | | | | | | | |
|---|---|---|---|---|---|---|---|---|---|---|---|---|
| | | | | (upper row: UV absorbability index, middle row: found data | | | | | | | | |
| | Thickness | Material | Content | of light transmittance, lower row: UV absorbability at 380 nm) | | | | | | | | |
| | μm | Used | mas. pt. | 280 | 330 | 370 | 375 | 380 | 385 | 390 | 395 | 400 |
| Example 7 | 80 | PP-A | 99.5 | 95 | 76 | 56 | 49 | 49 | 51 | 57 | 72 | 88 |
| | | UV-B2 | 0.25 | 18.3 | 2.8 | 4.0 | 5.7 | 10.8 | 21.4 | 38.1 | 59.6 | 77.8 |
| | | UV-C | 0.25 | — | — | — | — | B | — | — | — | — |
| Example 8 | 80 | PP-B | 99.5 | 95 | 73 | 44 | 48 | 48 | 47 | 56 | 72 | 87 |
| | | UV-B2 | 0.25 | 18.3 | 2.7 | 3.1 | 5.6 | 10.5 | 20.0 | 37.1 | 59.6 | 76.9 |
| | | UV-C | 0.25 | — | — | — | — | B | — | — | — | — |
| Example 9 | 80 | PP-A | 99.0 | 30 | 5 | 4 | 6 | 10 | 15 | 28 | 51 | 75 |
| | | UV-B2 | 0.5 | 5.8 | 0.2 | 0.3 | 0.7 | 2.1 | 6.3 | 18.5 | 42.1 | 66.4 |
| | | UV-C | 0.5 | — | — | — | — | A | — | — | — | — |
| Example 10 | 80 | PP-A | 99.0 | 18 | 5 | 7 | 10 | 29 | 51 | 60 | 64 | 86 |
| | | UV-B2 | 0.9 | 3.5 | 0.2 | 0.5 | 1.2 | 6.3 | 21.5 | 39.9 | 52.5 | 76.8 |
| | | UV-C | 0.1 | — | — | — | — | A | — | — | — | — |
| Example 11 | 40 | PP-A | 99.0 | 96 | 76 | 55 | 50 | 51 | 51 | 57 | 72 | 88 |
| | | UV-B2 | 0.5 | 18.6 | 2.8 | 3.9 | 5.8 | 11.2 | 21.6 | 37.9 | 59.6 | 78.0 |
| | | UV-C | 0.5 | — | — | — | — | B | — | — | — | — |
| Example 12 | 150 | PP-A | 99.5 | 40 | 41 | 21 | 18 | 21 | 22 | 32 | 53 | 77 |
| | | UV-B2 | 0.25 | 7.8 | 1.5 | 1.5 | 2.1 | 4.5 | 9.5 | 21.0 | 43.5 | 68.8 |
| | | UV-C | 0.25 | — | — | — | — | A | — | — | — | — |
| Comparative | 80 | PP-A | 99.5 | 100 | 100 | 100 | 100 | 100 | 100 | 100 | 100 | 100 |
| Example 6 | | UV-B2 | 0.5 | 19.3 | 3.7 | 7.1 | 11.7 | 21.9 | 42.3 | 66.5 | 82.3 | 88.9 |
| | | UV-C | 0 | — | — | — | — | B | — | — | — | — |
| Comparative | 80 | PP-A | 99.0 | 20 | 8 | 8 | 14 | 68 | 72 | 90 | 92 | 97 |
| Example 7 | | UV-B2 | 1 | 3.9 | 0.3 | 0.6 | 1.6 | 15.0 | 30.3 | 60.1 | 75.6 | 86.1 |
| | | UV-C | 0 | — | — | — | — | B | — | — | — | — |
| Comparative | 80 | PP-A | 99.0 | 20 | 8 | 8 | 13 | 48 | 61 | 75 | 77 | 92 |
| Example 8 | | UV-B2 | 0.95 | 3.8 | 0.3 | 0.6 | 1.5 | 10.5 | 25.6 | 50.2 | 63.5 | 82.1 |
| | | UV-C | 0.05 | — | — | — | — | B | — | — | — | — |
| Comparative | 80 | PP-A | 99.0 | 32 | 41 | 30 | 19 | 26 | 15 | 12 | 26 | 50 |
| Example 9 | | UV-B2 | 0.2 | 6.1 | 1.5 | 2.1 | 2.2 | 5.6 | 6.5 | 7.8 | 21.0 | 44.5 |
| | | UV-C | 0.8 | — | — | — | — | A | — | — | — | — |

TABLE 2-1

| | | | | Evaluation of | |
|---|---|---|---|---|---|
| | | Evaluation of Light | | Appearance | |
| | Evaluation | Transmittance*² | | Condition | Condition |
| | of Haze*¹ | 550 nm | 750 nm | 1 | 2 |
| Example 1 | 5/B | 93.0/A | 92.8/A | A | A |
| Example 2 | 6/B | 92.1/A | 92.0/A | A | A |
| Example 3 | 5/B | 92.5/A | 92.1/A | A | A |
| Example 4 | 5/B | 92.6/A | 92.1/A | A | A |
| Example 5 | 3/A | 92.9/A | 92.5/A | A | B |
| Example 6 | 8/B | 92.5/A | 92.9/A | A | B |
| Comparative | 5/B | 92.2/A | 92.4/A | A | A |
| Example 1 | | | | | |
| Comparative | 4/A | 92.3/A | 92.5/A | A | A |
| Example 2 | | | | | |
| Comparative | 5/B | 92.5/A | 92.8/A | C | C |
| Example 3 | | | | | |
| Comparative | 5/B | 91.8/A | 92.5/A | A | A |
| Example 4 | | | | | |
| Comparative | 5/B | 92.2/A | 92.1/A | C | C |
| Example 5 | | | | | |

*¹found data/evaluation
*²found data/evaluation

TABLE 2-2

| | | | | Evaluation of | |
|---|---|---|---|---|---|
| | | Evaluation of Light | | Appearance | |
| | Evaluation | Transmittance*² | | Condition | Condition |
| | of Haze*¹ | 550 nm | 750 nm | 1 | 2 |
| Example 7 | 5/B | 92.7/A | 92.6/A | A | A |
| Example 8 | 6/B | 92.7/A | 92.7/A | A | A |
| Example 9 | 5/B | 92.7/A | 92.7/A | A | A |
| Example 10 | 5/B | 92.6/A | 92.5/A | A | A |
| Example 11 | 4/A | 92.7/A | 92.7/A | A | A |
| Example 12 | 8/B | 92.0/A | 91.9/A | A | A |
| Comparative | 5/B | 92.2/A | 92.2/A | A | A |
| Example 6 | | | | | |
| Comparative | 5/A | 92.4/A | 92.9/A | A | A |
| Example 7 | | | | | |
| Comparative | 5/B | 92.2/A | 92.5/A | A | A |
| Example 8 | | | | | |
| Comparative | 5/B | 92.2/A | 92.7/A | C | C |
| Example 9 | | | | | |

*¹found data/evaluation
*²found data/evaluation

### INDUSTRIAL APPLICABILITY

The optical film of the present invention is excellent in optical characteristics and UV absorbability and is excellent in outward appearance in which the UV absorbent does not bleed out, and is therefore especially favorable for an optical film for polarizer protection. The polarizing plate to be produced by combining the optical film of the present invention and a polarizer can be effectively used in image display devices such as liquid crystal cell-containing liquid crystal display devices, organic electroluminescence display devices and touch panels.

1. An optical film formed of a polypropylene resin mixture containing (A) a polypropylene resin containing a propylene polymer, (B) a 2-(hydroxyphenyl)benzotriazole derivative 1, and (C) a 2-(hydroxyphenyl)benzotriazole derivative 2, wherein the 2-(hydroxyphenyl)benzotriazole derivative 2 (C) is 2-(2-hydroxy-3-tert-butyl-5-methylphenyl)-5-chlorobenzotriazole, and the content ratio of (C) to the total amount of (B) and (C) is from 8 to 60% by mass.

2. The optical film according to claim 1, wherein the 2-(hydroxyphenyl)benzotriazole derivative 1 (B) is at least one selected from 2-[2-hydroxy-5-(1,1,3,3-tetramethylbutyl)phenyl]benzotriazole and 2-(2-hydroxy-3,5-di-tert-pentylphenyl)benzotriazole.

3. The optical film according to claim 1, wherein the propylene polymer is a random copolymer of propylene and α-olefin.

4. The optical film according to claim 1, wherein the propylene polymer is a propylene copolymer produced by the use of a metallocene catalyst.

5. The optical film according to claim 1, wherein the total content of (B) and (C) in the polypropylene resin mixture is from 0.3 to 1.5% by mass.

6. The optical film according to claim 1, of which the light transmittance at a wavelength of 380 nm is at most 10%.

7. The optical film according to claim 1, which is used in a polarizer-protective film.

8. A polarizing plate comprising, as arranged on at least one surface of the polarizer therein, the optical film of claim 7.

9. An image display device, wherein the polarizing plate of claim 8 is used.

10. A liquid crystal display device, wherein a polarizer is used, and wherein the optical film of claim 7 is arranged on one surface of the polarizer on the backlight side thereof and the backlight is a fluorescent tube.
